(19) United States
(12) Patent Application Publication
(10) Pub. No.: US 2009/0263102 A1
(43) Pub. Date: Oct. 22, 2009

(54) Video Content Reproducing Apparatus and Video Content Reproducing Method

(75) Inventors: Masaaki Shimada, Tokyo (JP); Hidetoshi Mishima, Tokyo (JP)

Correspondence Address: BIRCH STEWART KOLASCH & BIRCH, PO BOX 747, FALLS CHURCH, VA, 22040-0747, US

(73) Assignee: MITSUBISHI ELECTRIC CORPORATION, Tokyo (JP)

(21) Appl. No.: 12/225,195

(22) PCT Filed: Jan. 17, 2007
(86) PCT No.: PCT/JP2007/050559

§ 371 Date: Sep. 16, 2008

(30) Foreign Application Priority Data
Apr. 25, 2006 (JP) 2006-120138

(51) Int. Cl. H04N 5/91

(52) U.S. Cl. 386/94; 386/E05.003

(57) ABSTRACT

An apparatus that, when reproducing video content that cannot be displayed normally, executes downconverted reproduction or notifies the user to avoid displeasing or upsetting the user, having a decoder block (13) that outputs a video signal reproduced from an optical disc to a video display apparatus (4), a display device authentication decision unit (22) that authenticates the video display apparatus (4) and decides whether to output the video signal as a digital video signal or after conversion to an analog video signal, a analog output decision unit (21) for determining play intervals, in the video signal recorded on the information recording medium, on which a restriction has been imposed by copyright protection processing on output after conversion to an analog video signal, and a system control unit (11) for controlling the decoder block (13) so as to output the video signal after performing a resolution-lowering conversion when reproducing a play interval on which the restriction has been determined to be imposed.

### TECHNICAL FIELD

The present invention relates to a video content reproducing apparatus and a video content reproducing method for reproducing video content recorded on an information recording-medium such as an optical disc, more particularly to a video content reproducing apparatus and a video content reproducing method for reproducing high definition (HD) video content and standard definition (SD) video content recorded as encoded and compressed streams on an information recording medium such as an optical disc.

### BACKGROUND ART

A known example of an apparatus for reproducing moving picture video content recorded on an information recording medium such as an optical disc is a reproducing apparatus conforming to the DVD (Digital Versatile Disc) standard, which is an optical disc standard. This type of video content includes, for example, digital video signals recorded in the form of encoded and compressed stream information. NTSC and other SD video data can be recorded and reproduced under the DVD standard. Under next-generation video content standards such as the BD (Blu-ray Disc) standard and HD-DVD standard, however, in addition to SD video data, HD video data can be recorded and reproduced.

The HD video format is a high definition video format equivalent to Hi-Vision broadcasting (analog broadcasting). In terms of numbers of pixels, the resolution of the conventional SD video format is, e.g., 720×480 dots or 720×576 dots, while the resolution of the HD video format is, e.g., 1920×1080 dots or 1920×1152 dots.

HD video content and SD video content can be recorded together on a next-generation optical disc. In that case, attribute information concerning the stream information can be pre-recorded for each title (for example, the play interval of each program) of the video content recorded on the optical disc, and a known type of video content reproducing apparatus can display the attribute information of all titles of the video content when the optical disc is inserted in the video content reproducing apparatus (see, for example Patent Document 1).

A reproducing apparatus for an optical disc on which both HD video and SD video are recorded is also described in Patent Document 2. In the art described in Patent Document 2, video content is recorded on an optical disc in both HD video and SD video formats, so that the content can be reproduced both by reproducing apparatus that supports HD video and by reproducing apparatus that supports only SD video; the reproduction control device in the reproducing apparatus decides for itself, through a control information command, whether it is of the type that supports HD video or SD video, and switches between reproducing the HD video and the SD video according to the result of this decision.

Two known forms of copyright protection processing (encryption processing) that check (authenticate) the video display apparatus connected to the video content reproducing apparatus to confirm that the video content recorded on the optical disc can be transferred as digital data, and then encrypt the video data before transferring the digital data, are HDCP (High-bandwidth Digital Content Protection system) and DTCP (Digital Transmission Content Protection). It is anticipated that the above copyright protection processing will be applied in particular to video content recorded in the HD video format, to prevent the production of high definition copies.

To strengthen the protection of HD video content, a future obligation has also been imposed on optical disc reproducing apparatus to be structured to output video signals only at a digital output terminal (HDMI or DVI, etc.), at which copyright protection processing (encryption processing) is easy, that is, not to output an HD analog video signal, for which copyright protection is difficult, from the video content reproducing apparatus. As a preliminary step toward this type of obligation, a structure that downconverts HD digital data to SD digital data, then outputs the data as analog data is also under study.

Patent document 1: Japanese Patent Application Publication No. 2002-170361 (pp. 2-3, FIG. 2)

Patent document 1: Japanese Patent Application Publication No. 2004-080196 (pp. 4-7, FIG. 4)

### DISCLOSURE OF THE INVENTION

### Problems to be Solved by the Invention

When a video content reproducing apparatus is connected to a video display apparatus that has only an analog video input terminal (HD or SD), however, the following situations (A-D) may arise.

(A) If the video content reproducing apparatus is completely prevented from outputting digital video content converted to an analog signal, then with a video display apparatus that can only display video from an analog signal, since no analog signal is input, nothing is displayed.

(B) If the video content reproducing apparatus is functionally limited to the output of HD digital video content converted to an SD analog signal, a video display apparatus will only be able to display downconverted SD analog data.

(C) When an optical disc on which both HD video content and SD video content are recorded is reproduced by a video content reproducing apparatus that is not permitted to convert digital video content to an analog video signal for output, the display on the video display apparatus may abruptly disappear, or SD video content may abruptly appear.

(D) When an optical disc on which both HD video content and SD video content are recorded is reproduced by a video content reproducing apparatus that downconverts HD digital video content to SD for output as an SD analog video signal, when HD video is being displayed on the video display apparatus, SD video may suddenly appear.

The problem is that when these situations occur, the user of the video content reproducing apparatus may misunderstand the situation and think that the video content reproducing apparatus is malfunctioning, and may be unsure of what to do in each situation.

An optical disc recording and reproducing apparatus that can readily record and reproduce HD video content and SD video content in a mixed manner on an optical disc is described in Patent Document 1. Patent document 1 does not disclose any means, however, for preventing the user of the video content reproducing apparatus from incorrectly thinking that a malfunction has occurred and being distressed when the above situations arise during the playing of an optical disc on which HD video content and SD video content are recorded in a mixed manner.

A reproducing apparatus that can switchably reproduce HD video content and SD video content from an optical disc on which HD video content and SD video content are both recorded is described in Patent Document 2. There is no disclosure in Patent Document 2, however, related to the case in which the only video input terminal of the connected video display apparatus is for analog input, the case in which the HD data output from the analog output terminal of the optical disc video reproducing apparatus is downconverted and output at standard resolution, or the case in which analog output is disabled.

Furthermore, in Patent Document 2 it is necessary for a single item of video content to be recorded on the optical disc as both SD video content and HD video content, so the single item of video content requires very much storage space, and the utilization efficiency of the optical disc and the data is poor.

The present invention addresses these problems of the prior art with the object of providing a video content reproducing apparatus and a video content reproducing method that can avoid causing a user displeasure or unease by executing downconverted reproduction or user notification when reproducing video content that cannot be displayed normally by the connected video display apparatus.

### Means of Solution of the Problems

In one aspect of the present invention, a video content reproducing apparatus for reproducing a video signal recorded with prescribed copyright protection processing on an information recording medium, having a video output means for outputting the reproduced video signal to a video display apparatus, is characterized by having a display device authentication decision unit for authenticating the video display apparatus and deciding, based on the result of the authentication, whether to output the video signal protected by the copyright protection processing as a digital video signal or after conversion to an analog video signal, an analog output decision unit for determining play intervals, in the video signal recorded on the information recording medium, on which a restriction has been imposed by the copyright protection processing on output after conversion to an analog video signal, and a control unit for controlling the video output means so as to output the video signal after performing a resolution-lowering conversion when reproducing a play interval on which the restriction has been determined to be imposed.

The above aspect may also include a copy control signal combiner for adding a copy control signal to an analog video signal to prevent copying or limit the number of times a copy can be made; when a play interval on which the restriction has been determined to be imposed is reproduced, the copy control signal combiner may add the copy control signal to the analog video signal.

In another aspect of the invention, a video content reproducing apparatus for reproducing a video signal recorded with prescribed copyright protection processing on an information recording medium, having a video output means for outputting the reproduced video signal to a video display apparatus, is characterized by having a display device authentication decision unit for authenticating the video display apparatus and deciding, based on the result of the authentication, whether to output the video signal protected by the copyright protection processing as a digital video signal or after conversion to an analog video signal, an analog output decision unit for determining play intervals, in the video signal recorded on the information recording medium, on which a restriction has been imposed by the copyright protection processing on output after conversion to an analog video signal, and at least one of a display unit for displaying the result determined by the analog output decision unit and a warning screen generator for outputting, to the video display apparatus, a video signal for displaying the result determined by the analog output decision unit.

The above aspect may also include a copy control signal combiner for adding a copy control signal to an analog video signal to prevent copying or limit the number of times a copy can be made; when a play interval on which the restriction has been determined to be imposed is reproduced, the copy control signal combiner may add the copy control signal to the analog video signal. The video output means may also skip or fast-forward a play interval on which the restriction has been determined to be imposed.

In still another aspect of the present invention, a video content reproducing apparatus for reproducing a video signal recorded with prescribed copyright protection processing on an information recording medium, having a video output means for outputting the reproduced video signal to a video display apparatus, is characterized by having a display device authentication decision unit for authenticating the video display apparatus and deciding, based on the result of the authentication, whether to output the video signal protected by the copyright protection processing as a digital video signal or after conversion to an analog video signal, an analog output decision unit for determining play intervals, in the video signal recorded on the information recording medium, on which a restriction has been imposed by the copyright protection processing on output after conversion to an analog video signal, and a warning screen generator for outputting a video signal for warning that a video interval of a title to be reproduced cannot be reproduced in the video format in which it was recorded on the information recording medium, based on the result determined by the analog output decision unit.

The above aspect may also include a copy control signal combiner for adding a copy control signal to the analog video signal to prevent copying or limit the number of times a copy can be made; when a play interval on which the restriction has been determined to be imposed is reproduced, the copy control signal combiner may add the copy control signal to the analog video signal. The video output means may also skip or fast-forward a play interval on which the restriction has been determined to be imposed.

### Effect of the Invention

According to the video content reproducing apparatus and video content reproducing method of the present invention, the possibility of display on the connected video display apparatus is determined for the video content of each title recorded on the information recording medium, and the effect of being able to avoid giving the user the misimpression of a malfunction or a feeling of unease is obtained by executing various processing such as, for example, processing for output following downconversion to a lower resolution, processing to skip or fast-forward a non-displayable interval, or processing to display a message concerning abnormal display.

### BRIEF DESCRIPTION OF THE DRAWINGS

FIG. 1 is a block diagram showing the general system configuration of a video content reproducing apparatus in a first embodiment of the present invention.

FIG. 2 shows the internal file data structure of the optical disc shown in FIG. 1.

FIG. 3 shows the logical file structure of the optical disc shown in FIG. 1.

FIG. 4 is a stream configuration diagram showing the internal data structure of the stream information files shown in FIG. 3.

FIG. 5 illustrates the syntax of the address management files shown in FIGS. 2 and 3.

FIG. 6 illustrates the syntax of the reproduction control information files shown in FIGS. 2 and 3.

FIG. 7 conceptually illustrates the program data structure managed by the reproduction control information files shown in FIGS. 2 and 3.

FIGS. 8(a) and 8(b) illustrate display modes in the connected video display apparatus when analog video output is limited to two forms by the video content reproducing apparatus shown in 1, FIG. 8(a) illustrating a Case 1 in which SD video output is enabled and HD video output is disabled at the analog video output terminal, FIG. 8(b) illustrating a Case 2 in which all video output is disabled at the analog video output terminal.

FIG. 9 is a waveform diagram illustrating a case in which a copy control signal is added to the waveform of the analog video signal for one field of HD video content recorded on the optical disc in FIG. 1.

FIG. 10 illustrates an exemplary method of device authentication by which the display device authentication decision unit shown in FIG. 1 detects the display functions of the video display apparatus.

FIG. 11 shows an exemplary warning screen displayed before the reproduction of a section of video content the output of which by an analog video signal is restricted, when the output terminal is a D3 terminal for analog video use.

FIGS. 12(a) to 12(c) show exemplary screens displayed before the reproduction of the segments in a playlist in which SD video content and HD video content are mixed, FIG. 12(a) indicating the recorded resolution of each play interval, FIG. 12(b) illustrating a Case 1 in which SD video is enabled at the analog video output terminal, FIG. 12(c) illustrating a Case 2 in which video output is disabled at the analog video output terminal.

FIG. 13 is a flowchart illustrating the operation of the video content reproducing apparatus shown in FIG. 1.

FIG. 14 shows an exemplary warning screen displayed by a video content reproducing apparatus in a second embodiment of the invention before the reproduction of a section of video content the output of which by an analog video signal is restricted, when the output terminal is a D3 terminal for analog video use.

FIGS. 15(a) to 15(c) show examples of reproduction by the video content reproducing apparatus in the second embodiment in the restricted reproduction mode, FIG. 15(a) indicating the recorded resolution of each play interval, FIG. 15(b) illustrating a case in which a restricted interval is skipped in reproduction (the first restricted reproduction mode), FIG. 15(c) illustrating a case in which the restricted interval is fast-forwarded in reproduction (the second restricted reproduction mode).

FIG. 16 is a flowchart illustrating the operation of the video content reproducing apparatus in the second embodiment.

### DESCRIPTION OF REFERENCE NUMERALS

1 video content reproducing apparatus, 2 optical disc, 3 control unit, 4 video display apparatus, 11 system controller, 12 temporary reproduction control information memory, 13 decoder block, 21 analog output decision unit, 22 display device authentication decision unit, 31 reproducing drive, 32 demultiplexer, 33 video decoder, 34 audio decoder, 35 warning screen (OSD) generator, 36 video mixer, 37 video signal converter, 38 copy control signal combiner, 41 inner circumference, 42 outer circumference, 51 lead-in area, 52 file management information area, 53 user data area, 54 lead-out area, 61 reproduction control information area, 62 stream information area, 71 reproduction control information file, 72 address management file, 81 stream information file, 100 root directory, 101 disc directory, 102 address management directory, 103 stream management directory, 130 packet, 131 header information, 132 ID, 141 “Start_PTS”, 142 “End_PTS”, 143 “num_of_program”, 144 “SPN_Program_Start”, 145 “Video_Packet_ID”, 146 “Audio_Packet_ID”, 147 “Stream_Packet_ID”, 148 “Format_Type”, 149 “CopyRight_Info”, 150 “Codec_Type”, 151 “num_of_Entry”, 152 “PTS_GOP_Start”, 153 “SPN_GOP_Start”, 161 “num_of_PlayList”, 162 “num_of_Play_Interval”, 163 “Stream_name”, 164 “Start_Time”, 165 “End_Time”, 181 copy control signal, 191 “normal play” button, 192 “stop playing” button, 193 digital video output status display area, 194 playlist configuration information display area, 201 “restricted play mode” button, 211 first restricted play mode, 212 second restricted play mode.

### BEST MODE FOR CARRYING OUT THE INVENTION

### First Embodiment

In the first embodiment, a case in which the video display apparatus connected to the video content reproducing apparatus does not have an input terminal for a high definition (HD) digital video signal on which prescribed copyright protection processing utilized in the video content reproducing apparatus has been performed (a case, for example, in which it has only an analog video input terminal), and HD video content for which copyright protection processing is designated is included in one or more titles of video content (one play interval per title) on the optical disc information recording medium. Before reproducing a play interval with HD video content for which copyright protection processing is designated, for example, the video content reproducing apparatus in the first embodiment displays, for the user of the video content reproducing apparatus, a message (warning screen) stating that the video signal to be output is restricted and even high definition content will be displayed at standard definition, or a message (warning screen) stating that the video signal to be output is restricted and no picture will be displayed. The restriction on the video signal to be output indicates that high definition video content recorded on the optical disc is not to be output digitally as a video signal with its original high definition, or is not to be output as an analog signal, as when the part of the video content having an HD video format is to be output after conversion to an SD video format, or when the part of the video content having an HD video format is not to be output (not to be displayed).

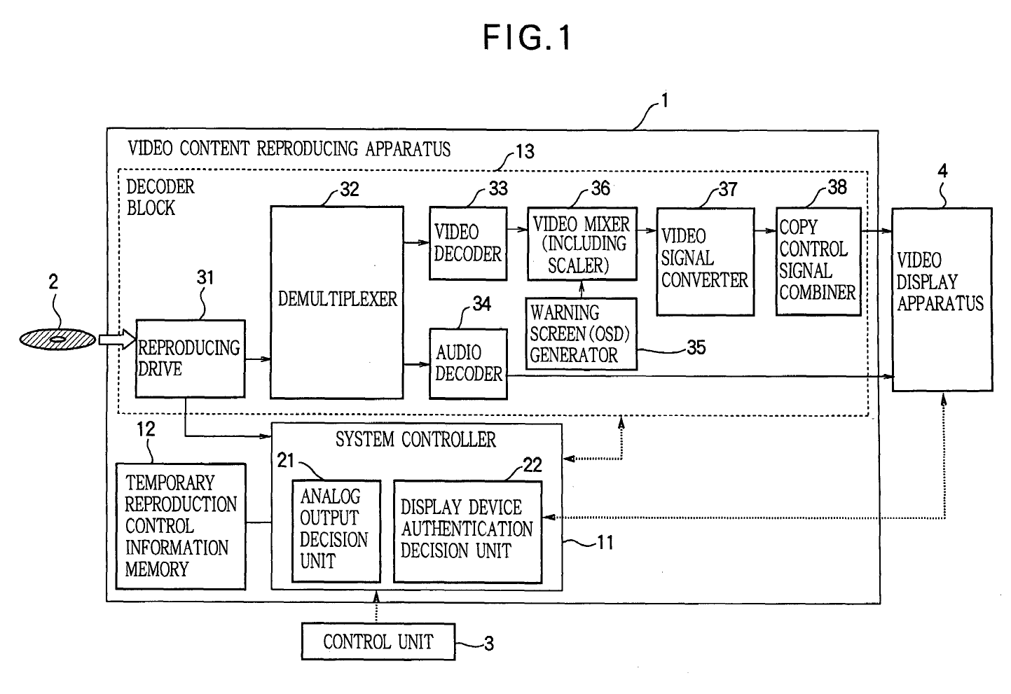

FIG. 1 is a block diagram showing the general system configuration of a video content reproducing apparatus 1 in a first embodiment of the present invention. In FIG. 1, the video content reproducing apparatus 1 is an optical disc video content reproducing apparatus for reproducing digital video content from an optical disc 2 and outputting a video signal to a video display apparatus 4. By interpreting the content of commands given through a control unit 3 and by controlling a decoder block 13, the video content reproducing apparatus 1 can reproduce arbitrary stream information from the optical disc 2. For example, if the user of the video content reproducing apparatus 1 uses the control unit 3 to enter an instruction (command) to reproduce given video content from a list of titles playable from the optical disc 2, the instruction is passed to a system controller 11, and the system controller 11 issues a play instruction to the decoder block 13. Upon receiving the play instruction, the decoder block 13 reproduces video content having the specified title from the optical disc 2. From an optical disc on at least part of which moving picture video content is recorded by a high-definition digital video signal with prescribed copyright protection processing designated, the video content reproducing apparatus 1 can reproduce the video content of each title, which is the unit of reproduction of video content, (a single play interval to which a single title is assigned) and can output the reproduced video content after performing the prescribed copyright protection processing. In the first embodiment, a case in which a warning or the like based on the result of a determination by a display device authentication decision unit 22 is output to the video display apparatus 4 is described, but the video content reproducing apparatus 1 itself may have a display unit (not shown) and the display unit may display the result of the determination. In the first embodiment, the result of the determination is output to the video display apparatus 4 or the display unit (not shown) to inform the user of the situation, so that circumstances in which the occurrence of an abnormal display state gives the user the misimpression of a malfunction, or in which the user feels distressed because the user does not know how to deal with each abnormal display state, can be avoided.

The optical disc 2 is an optical recording medium to be played, on which multiplexed digital (encoded) video content is recorded as stream information together with reproduction control information for the stream information. The optical disc 2 is assumed to include HD video content on which, for example, copyright protection processing is designated for the video content (play interval) of one or more titles. However, the information recording media played by the video content reproducing apparatus and the video content reproducing method of the present invention are not limited to optical discs; they may be arbitrary information recording media other than optical discs (such as semiconductor memory or a transportable hard disk drive), provided the information recording media contain video content for which copyright protection processing is designated.

The control unit 3 is a unit that can be operated by the user to enter instructions or selections. The control unit 3 is, for example, a control panel disposed in the front panel of the video content reproducing apparatus 1, or a remote control unit or the like that can send signals by infrared or radio waves to control the video content reproducing apparatus 1.

The video display apparatus 4 is a display apparatus such as a television broadcast receiver using a CRT, liquid crystal display panel, or plasma display panel, for example. The video display apparatus 4 is an apparatus for use in viewing digital video content reproduced by the video content reproducing apparatus 1; it displays video pictures in accordance with reproduced video signals and outputs audio in accordance with audio signals output from a audio decoder 34. As noted above, the video display apparatus 4 of the first embodiment is a video display apparatus that does not have an input terminal for an HD digital video signal on which prescribed copyright protection processing utilized in the video content reproducing apparatus 1 has been performed; it has only an analog video input terminal, for example. Incidentally, a video display apparatus that, differing from the first embodiment, has an input terminal for an HD digital video signal on which prescribed copyright protection processing has been performed has a digital input terminal supporting the above-mentioned HDCP; after device authentication is performed between this video display apparatus 4 and the video content reproducing apparatus 1, the video content reproducing apparatus 1 outputs a signal obtained by performing the prescribed copyright protection processing (encryption processing) on the reproduced video signal, and the video display apparatus 4 performs decryption and displays the result.

The system controller 11 controls the whole of the video content reproducing apparatus 1. For example, when the user of the video content reproducing apparatus 1 uses the control unit 3 to enter an instruction (command) to reproduce desired video content from among the playable titles on the optical disc 2, and the instruction is passed to the system controller 11, the system controller 11 first reads the playlist information describing the desired program from the reproduction control information held in a temporary reproduction control information memory 12. The playlist information includes one or more play intervals, referred to as play items. From the playlist information, the system controller 11 then obtains the physical address of a location in the optical disc 2 where an arbitrary file, specified by a play item, of stream information in the playlist is recorded; the file of stream information is read from the physical address and reproduced by a reproducing drive 31; and the reproduced stream information is output to the video display apparatus 4 through a demultiplexer 32, video decoder 33, audio decoder 34, and other components.

Prior to the reproduction of each reproduction unit, the system controller 11 determines, in accordance with the result of detection by the display device authentication decision unit 22, whether the HD video content recorded on the optical disc 2 should be output as-is at high definition or whether it should be output after its resolution is changed to standard definition (SD) by a video signal converter 37. Prior to reproduction of each reproduction unit, the system controller 11 also determines, in accordance with the result of detection by an analog output decision unit 21, whether the video content can be output as analog data and, if the analog video content has high resolution, whether it should be converted to standard definition. If the results of these determinations indicate that the HD video content cannot be output as-is at high definition, the system controller 11 generates and outputs a video signal that can display a warning screen on the video display apparatus 4.

If the result of detection by the display device authentication decision unit 22 indicates that an HD digital video signal cannot be displayed and that only an HD analog video signal or standard-definition analog video signal can be displayed, and the result of detection by the analog output decision unit 21 indicates that all analog data output is restricted, the system controller 11 has the warning screen generator 35 generate and output a message (warning screen) stating that nothing can be displayed on the screen. If the result of detection by the display device authentication decision unit 22 indicates that an HD digital video signal cannot be displayed and the result of detection by the analog output decision unit 21 indicates that analog data output is enabled only at standard definition, the system controller 11 has the warning screen generator 35 generate and output a warning screen stating that the HD digital video signal will be displayed on the screen at standard definition.

If a reproduction unit that has been judged as not displayable at high definition is detected in the reproduction units of the video content recorded on the optical disc 2 when a plurality of units of video content are reproduced continuously, the system controller 11 may skip the play interval of that reproduction unit and reproduce the play interval of the next reproduction unit, or may fast-forward the play interval of that reproduction unit.

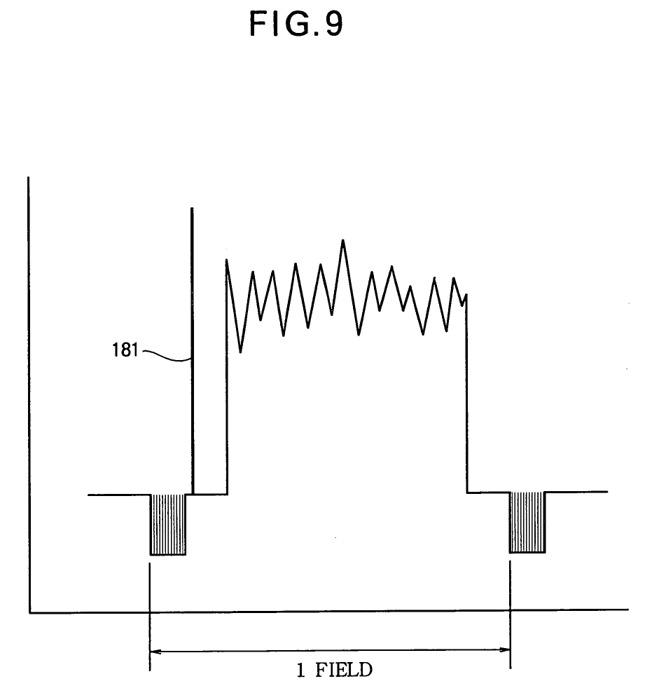

With regard to the video signal of a reproduction unit for which it has been determined, in accordance with the result of detection by the display device authentication decision unit 22, that its resolution will be converted by the video signal converter 37 prior to output, and for which it has also been determined, in accordance with the result of detection by a analog output decision unit 21, that the video content will be output in analog form, the system controller 11 outputs the video signal after converting the video format to a resolution that can be displayed by the connected video display apparatus 4, changing the video signal to analog form, and adding a copy control signal 181 (which will be described later with reference to FIG. 9) to the analog video signal to prevent copying or limit the number of times a copy can be made by a copy control signal combiner 38, which will be described later.

If HD video content cannot be output as-is at high definition, the system controller 11 may display the result of the determination based on the result of detection by the display device authentication decision unit 22 on a display unit (not shown) provided in the video content reproducing apparatus 1 itself, or may output the result after converting it to a video signal that can be displayed by the video display apparatus 4.

The temporary reproduction control information memory 12 temporarily stores the reproduction control information pertaining to the stream information recorded on the optical disc 2 so that it can be accessed quickly from the system controller 11. The reproduction control information here includes video attribute information of video streams separated from the stream information recorded on the optical disc 2, audio attribute information of separated audio streams, and information indicating the correspondence between the reproduction starting time information and the reproduction starting position information of access units (normally GOP units) of the stream information.

As shown in FIG. 1, the decoder block 13 includes units denoted by reference numerals 31 to 38, which will be described later; it reproduces digital video content from the optical disc 2, performs demultiplexing, video decoding, audio decoding, video mixing, video signal conversion, and the addition of the copy control signal to the reproduced signal, and outputs the video signal and audio signal to the video display apparatus 4.

For the video content (play interval) of each title forming one reproduction unit of the video content on the optical disc 2, from the video stream attribute information in the reproduction control information held on the optical disc 2, the analog output decision unit 21 checks whether an analog output restriction is imposed or not, that is, whether analog video output is restricted in the segment. If the stream information file contains an analog output restriction flag such as an ICT (an Image Constraint Token in the DTCP descriptor stipulated by MPEG-TS), the ICT and other information may also be used to gather video output restriction information for each play interval.

The display device authentication decision unit 22 detects functions of the video display apparatus 4 connected to the video content reproducing apparatus 1 by a video output cable. For example, for the video content (play interval) of each title, which is the reproduction unit of the video content, the display device authentication decision unit 22 uses a device authentication procedure such as DTCP to check whether it is possible to transmit the stream information on the optical disc 2 as a digital video signal to the video display apparatus 4 and display the video signal. If display is possible, the display device authentication decision unit 22 detects whether it can display a transmitted digital video signal on which the prescribed copy protection processing has been performed by undoing the protection processing. If the video display apparatus 4 has only an analog connector, communication for a device authentication procedure such as DTCP is impossible, so the display device authentication decision unit 22 detects that normal operation is impossible and thus detects that the video display apparatus 4 is only for analog input.

The analog output decision unit 21 and display device authentication decision unit 22 are shown as being implemented as firmware or the like in the system controller 11 in the first embodiment, but they may be located outside the system controller 11, or may be implemented as hardware having the corresponding functions.

The reproducing drive 31 reads video content stream information and its reproduction control information from the optical disc 2 and outputs the stream information of the reproduced file to a demultiplexer 32. The reproduction control information is output to the temporary reproduction control information memory 12 at this time.

The compressed file of stream information read by the reproducing drive 31 is input to the demultiplexer 32, which separates the file into a video stream and an audio stream, the video stream being output to the video decoder 33 and the audio stream being output to the audio decoder 34.

The video decoder 33 performs decoding (e.g., decoding by the MPEG-2 method) of the video stream (which has been encoded by, e.g., the MPEG-2 method) separated by the demultiplexer 32 and obtains a digital video signal of the video content.

The audio decoder 34 performs decoding (e.g., decoding by the AC-3 method) of the audio stream (which has been encoded by, e.g., the AC-3 method) separated by the demultiplexer 32 and obtains a digital audio signal of the content.

The warning screen generator (OSD: On Screen Display) 35 outputs video signals for displaying, on the screen, warning displays, device operating status displays, function selection screens, and so on, which are generated by the system controller 11. The warning screen generator 35 in the first embodiment generates, and outputs to a video mixer 36, a warning screen stating either that a high definition digital video signal will be displayed at standard definition or that no picture will be displayed.

The video mixer 36 performs video mixing so that the image produced by the digital video signal generated by the warning screen generator 35 is added to the image produced by the digital video signal generated by the video decoder 33, and outputs the video content produced by the mixed digital video signal.

The video signal converter 37 can convert the video format of the video content to a resolution that can be displayed by the video display apparatus 4 (for example, by converting high definition to standard definition) and can also convert the digital video signal of digital video content to an analog video signal.

For an analog video signal, under the control of the system controller 11, the copy control signal combiner 38 generates a signal by adding a copy control signal to the analog video signal of the video content output from the video mixer 36. The copy control signal is a signal added to an analog video signal to prevent copying or limit the number of times a copy can be made. The copy control signal combiner 38 performs digital encryption, in accordance with the above-mentioned HDCP, for example, on the digital video signal, which it then outputs as a digital video signal.

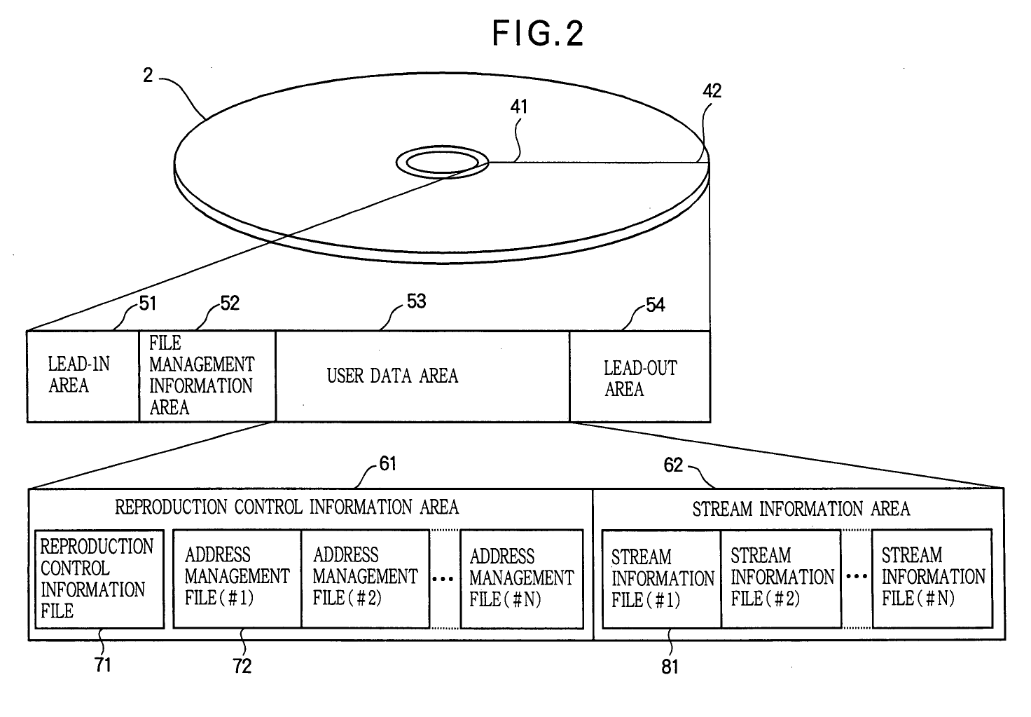

FIG. 2 shows the internal file data structure of the optical disc 2 shown in FIG. 1. In FIG. 2, the file data of the optical disc 2 are recorded from the inner circumference 41 toward the outer circumference 42 on the optical disc 2.

Starting information, physical characteristics of the optical disc 2, and so on are recorded in a lead-in area 51. The file system information of the optical disc 2 is managed in a file management information area 52. The user data area 53 is an area in which information from a video content supplier can be pre-recorded. Disc termination information is recorded in a lead-out area 54.

The user data area 53 includes a reproduction control information area 61 and a stream information area 62. In the stream information area 62, one or more stream information files 81 indicating a series of multiplexed and compressed streams are recorded. A stream information file 81 is a file of multiplexed video and audio streams. The demultiplexer 32 generates video and audio streams by demultiplexing the stream information file 81. The description below will proceed under the assumption that the video stream information is encoded in compression units such as the GOPs (Groups of Pictures) designated in the ES (Elementary Stream) format of the MPEG-2 system.

One reproduction control information file 71 and one or more address management files 72 are recorded in the reproduction control information area 61. The reproduction control information file 71 includes play interval information and play sequence information of programs, video content information for each stream information file 81, and so on. The address management files 72 are in a one-to-one correspondence with the stream information files-81, the correspondence being established by file names or the like. Address management file (#1) 72 contains the start address, display starting time information, and so forth of each access point in the corresponding stream information file (#1) 81.

One access point may have a plurality of GOPs. In the first embodiment, a case in which a single reproduction control information file 71 is present is described, but the information may be divided into a plurality of files and managed separately. A case in which all the playlist information held on the optical disc 2 is held in the reproduction control information file 71 is shown in the first embodiment, but the playlist information representing different programs may be held and managed in different files.

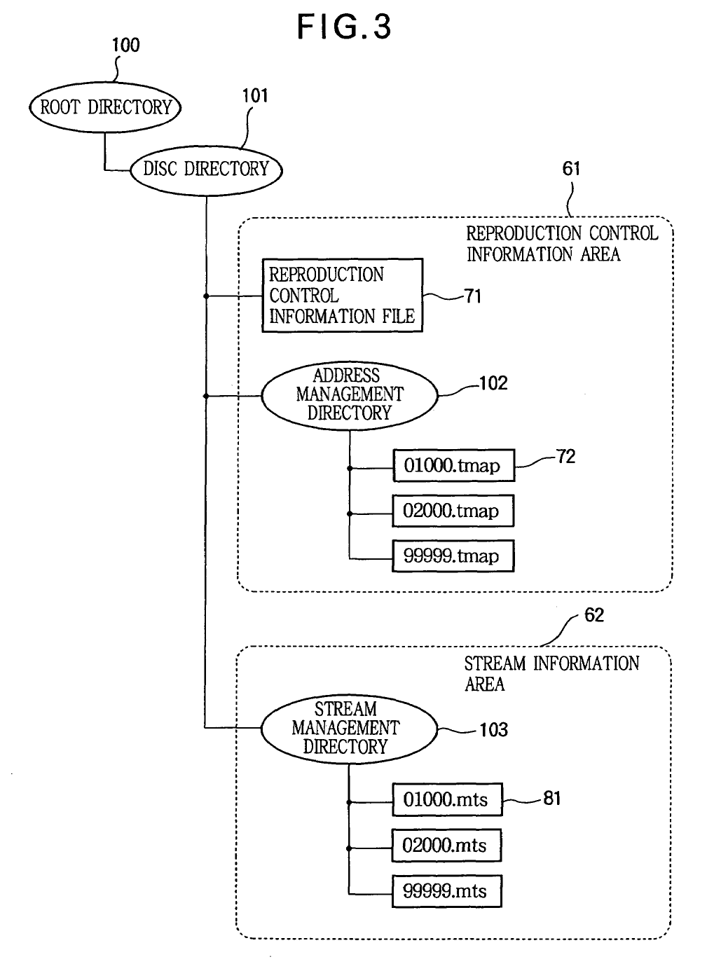

FIG. 3 shows the logical file structure of the optical disc 2 shown in FIG. 1. The root directory 100 is the directory structure at the highest level of the logical hierarchical file structure. The disc directory 101 is the directory structure disposed on the level below the root directory 100.

The disc directory 101 includes the reproduction control information file 71, which is disc video content management information recorded on the optical disc 2, an address management directory 102, which is a folder in which the address management files 72 are recorded, and a stream management directory 103, which is a folder in which the stream information files 81 are recorded.

The following description will assume that the one-to-one correspondence between the address management files 72 and the stream information files 81 in FIG. 3 is given by five-digit file names. The file names can be any five-digit numbers; the numbers need not be consecutive. FIG. 3 shows a case in which the address management files 72 and the stream information files 81 are placed in separate directories, but the two types of files may be placed in the same directory and may also be placed directly under the root directory 100. In the first embodiment, the stream information files 81 are recorded so as to form a one-to-one correspondence with the address management files 72, as described above, but a plurality of stream information files 81 may be recorded in correspondence with a single address management file 72.

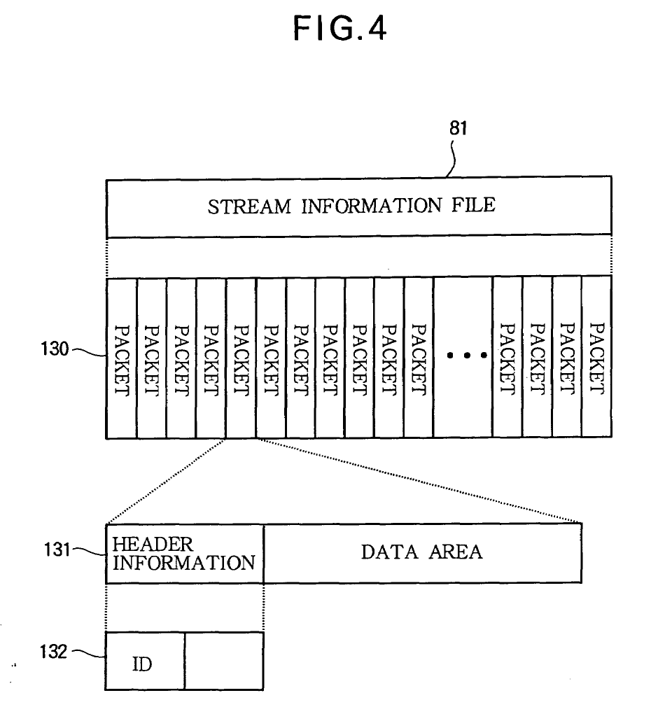

FIG. 4 is a stream configuration diagram showing the internal data structure of the stream information files 81 shown in FIG. 2. A stream information file 81 is composed of fixed-length data units, referred to as packets 130. Video data, audio data, and stream management data are divided into packets 130, then multiplexed to form the stream information file 81. Each packet 130 begins with header information 131; the data in the packet 130 are identified by an ID (identification) 132 written in the header information 131. The demultiplexer 32 in FIG. 1 separates the data into video data, audio data, stream management data, and so on by recognizing the IDs 132.

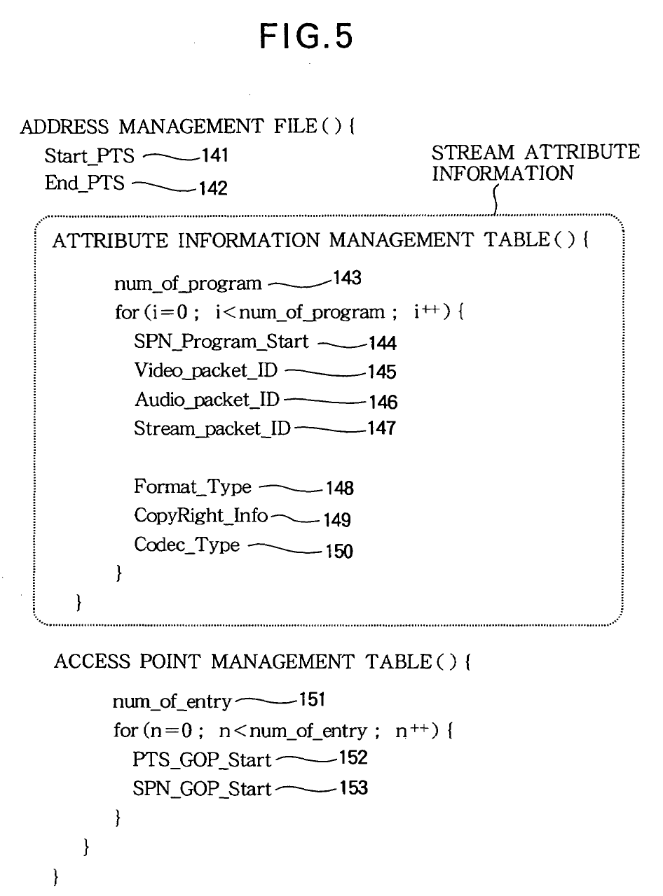

FIG. 5 illustrates the syntax of the address management files 72 shown in FIGS. 2 and 3. “Start_PTS” 141 indicates the PTS (presentation time stamp) of the first video frame of the target stream information file 81, and “End_PTS” 142 indicates the PTS of the last video frame.

Each stream information file 81 in FIGS. 2 and 3 is divided into one or more management units referred to as programs. Stream attribute information concerning the video content, audio information, and other information given by the digital video signal is switched in units of programs. The program divisions in the stream information file 81 are made at, for example, places where SD video content is switched to HD video content. The stream attribute information, the IDs of the packets forming the stream, and so on are stored in an attribute information management table for each program in the stream.

The value of “num_of_program” 143 indicates the total number of programs, and the following loop of statements (starting from “for”) is repeated as many times as the value of “num_of_program” 143. The value of “SPN_Program_Start” 144 indicates the relative number of packets from the beginning of the stream information file 81 to the beginning of the program. “Video_packet_ID” 145, “Audio_packet_ID” 146, and “Stream_packet_ID” 147 indicate IDs of packets to which the streams of video data, audio data, and stream management data included in the stream information file 81 are assigned. The stream management data includes attribute information of the individual streams in the multiplexed stream, analog restriction flag information such as the above-mentioned ICT, and so on.

“Format_Type” 148 indicates resolution information, and “CopyRight_Info” 149 indicates video content protection strength information and the like. The analog output decision unit 21 in FIG. 1 judges from the information in the “Format_Type” 148 whether the program is SD video content or HD video content.

The attribute information of each program may specify a video codec type, audio codec type, video frame rate, audio sampling rate, and other information. Finer control may be performed by combining these types of information. The access point management table is a recorded list of stream-read starting positions and reproduction starting times of individual access points; search, random access, and other special reproduction functions can be performed by use of this information. If the video data are encoded as an MPEG-2 video stream, the beginning of a GOP (Group of Pictures) corresponds to an access point, and the access point management table indicates which packet in the stream information file 81 contains the beginning of the GOP.

The value of “num_of_entry” 151 indicates the total number of access points, and the following loop of statements (starting from “for”) is repeated as many times as the value of “num_of_entry” 151. “PTS_GOP_Start” 152 indicates the display start PTS of the access point, and the value of “SPN_GOP_Start” 153 indicates the relative number of packets from the beginning of the stream information file 81 to the beginning of the access point. Since the packets have a fixed length, the relative number of bytes from the beginning of the stream information file 81 to the beginning of the access point can be obtained by multiplying the value of “SPN_GOP_Start” 153 by the number of bytes per packet. To perform random access reproduction, the video content reproducing apparatus 1 calculates the position of the access point on the disc from the number of bytes from the beginning of the stream information file 81.

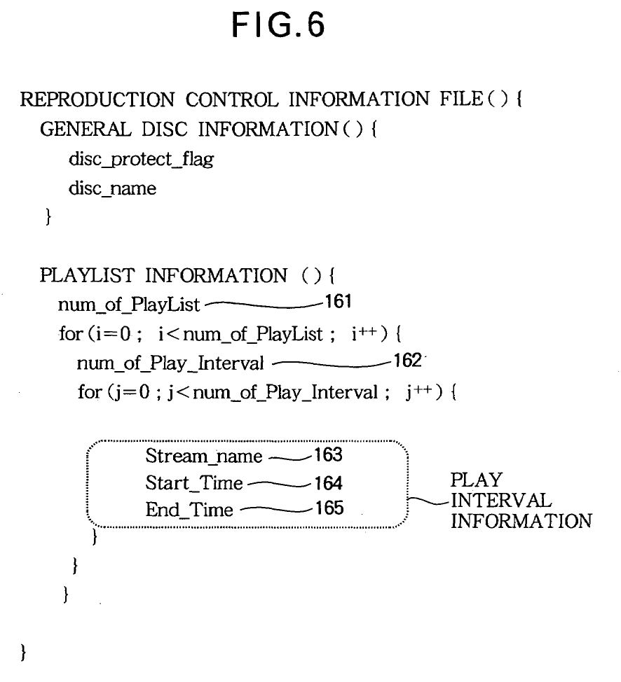

FIG. 6 illustrates the syntax of the reproduction control information files 71 shown in FIGS. 2 and 3. The general disc information indicates information about the disc, including disc protection settings and disc name setting information.

The playlist information holds information concerning playlists, which give program-by-program information. The value of “num_of_PlayList” 161 indicates the total number of playlists recorded on the optical disc 2, and the following loop of statements is repeated as many times as the value of “num_of_PlayList” 161. The value of “num_of_Play_Interval” 162 indicates the total number of play interval information items in the playlist, and the following loop of statements is repeated as many times as the value of “num_of_Play_Interval” 162.

An item of play interval information, also referred to as a play item, includes a “stream_name” 163, “Start_Time” 164, and “End_Time” 165. The “stream_name” 163 indicates the file name of the stream information file 81 to be reproduced, and “Start_time” 164 and “End_time” 165 indicate the reproduction starting time and reproduction ending time of a prescribed interval of the stream information file 81 to be reproduced. In the first embodiment, the presentation time stamps (PTSs) of the video data are used as “Start_time” 164 and “End_time” 165. From this information, the video content reproducing apparatus 1 can detect which interval of the stream information file 81 to reproduce.

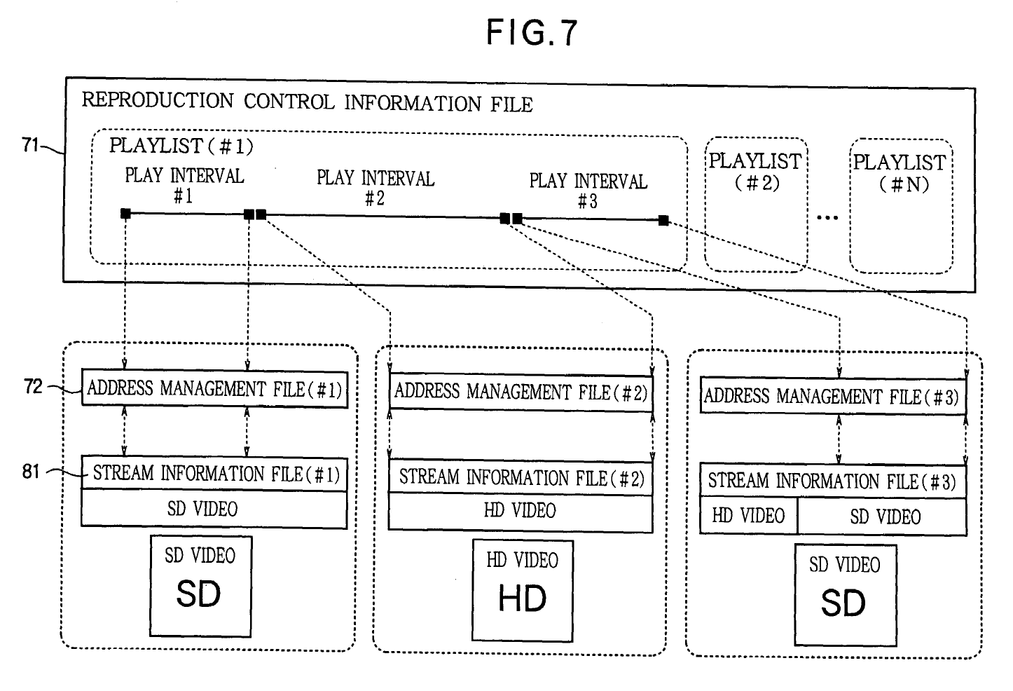

FIG. 7 conceptually illustrates the program data structure managed by the reproduction control information files 71 shown in FIGS. 2 and 3. The playlists in FIG. 7 correspond to programs that can be selected by the user of the video content reproducing apparatus 1, and the information in the playlists is the information recorded in the reproduction control information file 71. A playlist is a group of designated play intervals in the stream information files 81. Playlists can be formed in a variety of patterns; for example, a playlist may be a single play interval in a single stream information file 81, a plurality of play intervals in a single stream information file 81, or designated play intervals in different stream information files 81.

A play interval is designated by specifying the name (“stream_name” 163) of the address management file 72 to be reproduced, the reproduction start point (“Start_Time” 164), and the end point (“End_Time” 165). By combining this with the information in the access point management table (FIG. 5) in the address management file 72, the starting position of a given access point in the stream information file 81 can be found. This can be used in special reproduction control of the stream information file 81, time search, and so on.

FIG. 7 shows an exemplary reproduction model in the first embodiment. In the example shown in FIG. 7, playlist #1 has three play intervals #1, #2, and #3, which are reproduced in this order. A single playlist may include play intervals having different video formats. For example, a playlist may be formed that displays SD video content during the reproduction of play interval #1, HD video content during the reproduction of play interval #2, and SD video content during the reproduction of play interval #3.

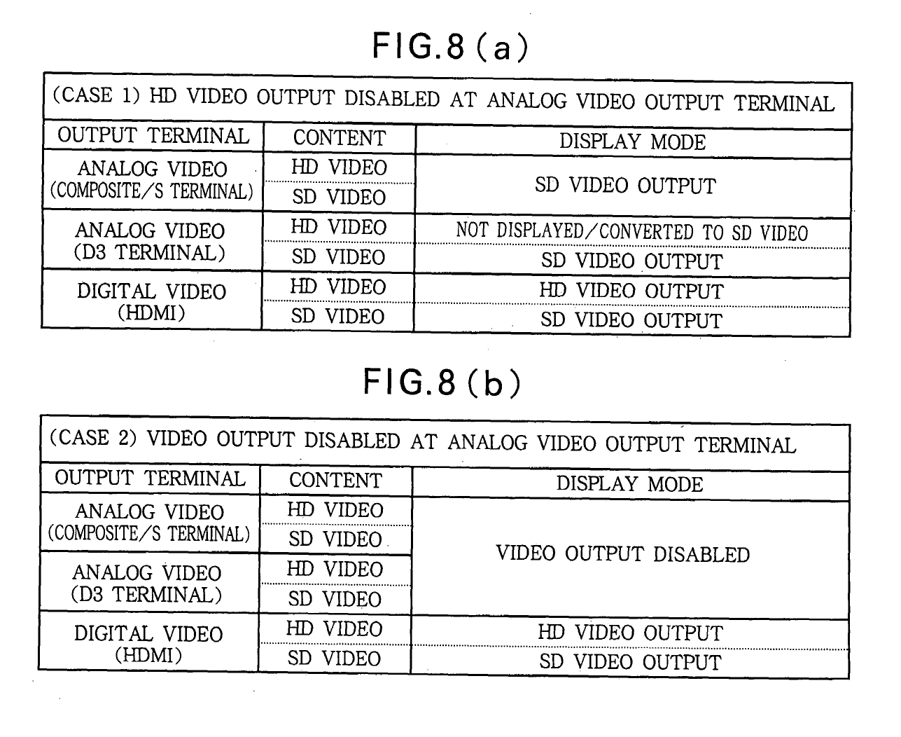

FIGS. 8(a) and 8(b) illustrate display modes in the connected video display apparatus 4 when analog video output is limited to two forms by the video content reproducing apparatus 1 shown in 1, FIG. 8(a) illustrating a Case 1 in which SD video output is enabled and HD video output is disabled at the analog video output terminal, FIG. 8(b) illustrating a Case 2 in which all video output is disabled at the analog video output terminal. In FIGS. 8(a) and 8(b), the case with a digital video (HDMI) output terminal is indicated for the sake of comparison. The first embodiment is especially effective in Case 1 in FIG. 8(a). If video output to the analog video output terminal is restricted, the system controller 11 decides whether or not the video picture can be displayed on the connected video display apparatus 4 in accordance with the result of the video format type analysis (which distinguishes between the SD video format and the HD video format) and the device authentication information with the video display apparatus 4, and if it decides to display the video picture, it determines the display definition (degree of high resolution).

The specific example of the D3 terminal (an analog video output terminal at which HD video content output is enabled) in Case 1 in FIG. 8(a) will be described in detail. The D3 terminal is an output terminal from which the Hi-Vision signal of an analog high-definition broadcast can be displayed, and HD video content recorded on the optical disc 2 can be displayed after being converted to an analog HD video signal because there is no restriction at present. If the analog video output restriction of Case 1 is imposed in the future, it will then become impossible to output the HD video content recorded on the optical disc 2 directly for display as HD video content at high definition. In that case, either video output (display) itself may be disabled, or the reproduced HD video content may be output (displayed) as SD video content at a lowered resolution. With the output restriction of Case 1, SD video content can be displayed directly as SD video content without changing the resolution.

Case 2 in FIG. 8(b) is a different example. The digital video (HDMI) output terminal is not included in the first embodiment but is indicated for the sake of comparison. Because video signal output to the analog output terminal is disabled in Case 2, no video signals can be output from the composite terminal, S terminal, and D1 to D5 terminals, which are the analog output terminals of the video content reproducing apparatus 1. Video signals can be output only from the digital video output terminal, and this requires device authentication in the video content reproducing apparatus 1. Accordingly, a video display apparatus 4 that has an analog video input terminal but no digital video input terminal cannot display any HD video content recorded on the optical disc 2.

FIG. 9 is a waveform diagram illustrating the addition of a copy control signal 181 to the waveform of the analog video signal for one field of HD video content recorded on the optical disc 2 in FIG. 1. If the copy control signal 181 is added to the analog video signal of video content output from the video mixer 36, the system controller 11 in FIG. 1 adds the copy control signal 181 to the vertical blanking interval of the analog video signal of the video content. Because the copy control signal 181 is added to the vertical blanking area in the analog video signal of the video content, the copy control signal 181 does not affect the displayed video, and the video display apparatus 4 connected to the video content reproducing apparatus can display a normal video picture. For a recording apparatus such as a VTR, however, the copy control signal 181 affects AGC (automatic gain control), disabling normal recording and thus preventing dubbing. The method of adding the copy control signal 181 to the analog video signal is not limited to the method described above; copy control signals employed in other copy protection techniques, such as adding a copy control signal by inverting the color burst, for example, may be used instead.

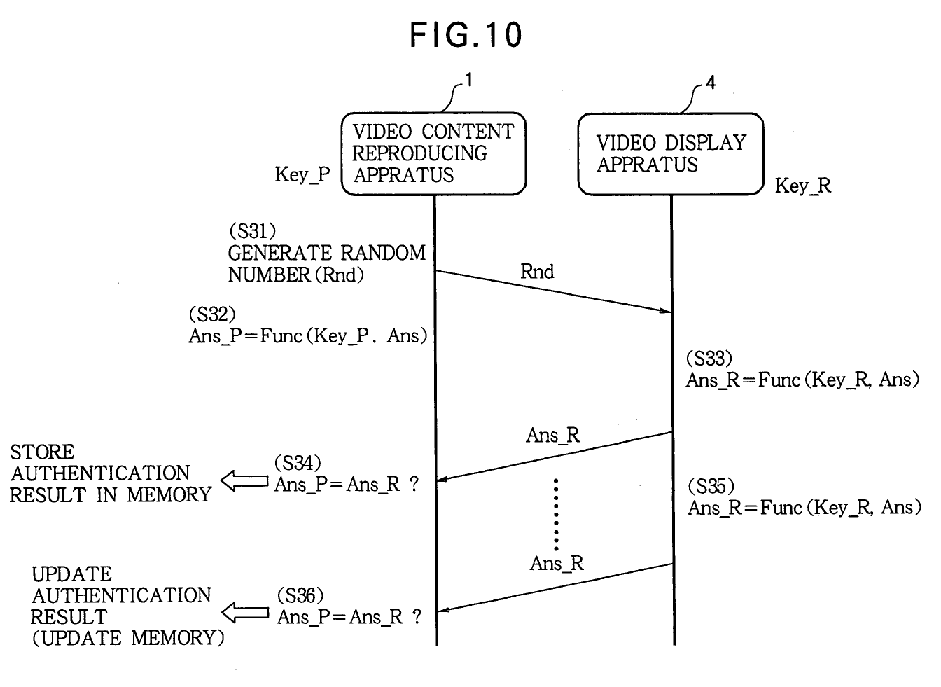

FIG. 10 illustrates an exemplary method of device authentication by which the display device authentication decision unit 22 shown in FIG. 1 detects the display functions of the video display apparatus 4 by communication through a control line. The video content reproducing apparatus 1 performs device authentication of the connected video display apparatus 4 by the exemplary method illustrated in FIG. 10, and the video display apparatus 4 connected to the video content reproducing apparatus 1 also performs device authentication of the video content reproducing apparatus 1 by a similar procedure. The video content reproducing apparatus 1 first generates a random number “Rnd” in accordance with an instruction from the system controller 11 and sends the random number “Rnd” to the video display apparatus 4 (step S31). The video content reproducing apparatus 1 also performs calculations in accordance with a prescribed formula on the random number “Rnd” and an encryption key “Key_P” already held by the video content reproducing apparatus 1 to obtain an answer “Ans_P” (step S32).

The video display apparatus 4, which also holds an encryption key “Key_R”, uses it and the received random number “Rnd” to calculate an answer “Ans_R” and sends the answer “Ans_R” to the video content reproducing apparatus 1 (step S33). The video content reproducing apparatus 1 checks whether the answer “Ans_P” obtained in step S32 and the received answer “Ans_R” match, and if they do, stores in the temporary reproduction control information memory 12 information indicating that it was able to execute device authentication normally (step S34). The process of steps S33 and S34 may be repeated at regular intervals (of three seconds, for example), as shown by the repetition of steps S33 and S34 and steps S35 and S36 in FIG. 10, to make continuing device authentication checks.

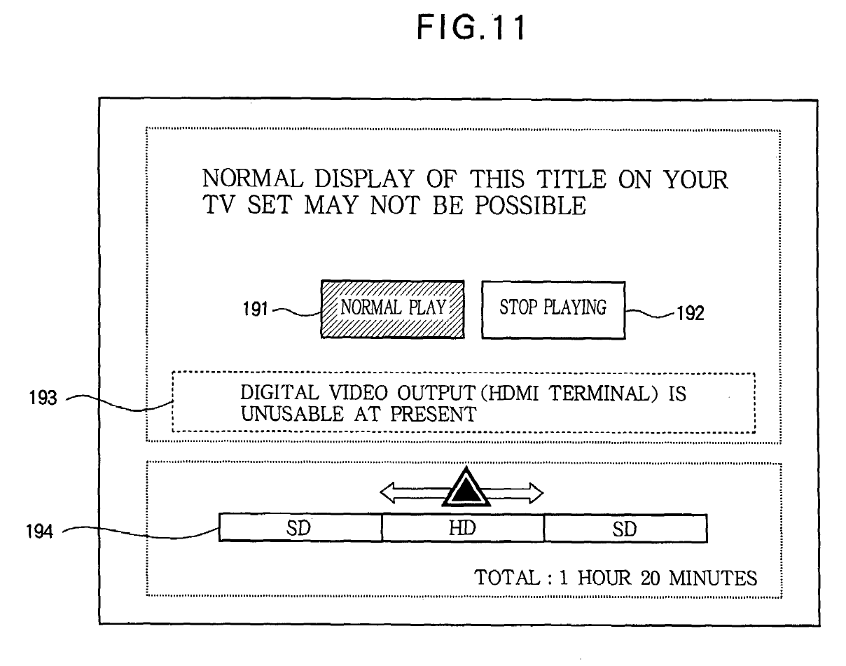

FIG. 11 shows an exemplary warning screen displayed before the reproduction of a section of video content the output of which by an analog video signal is restricted, when the analog video output terminal (D3 terminal) is used as in FIG. 8 (a). The warning screen in FIG. 11 displays two buttons: a “normal play” button 191 and “stop playing” button 192; acting through the control unit 3, by pressing a key or the like corresponding to the button, the user of the video content reproducing apparatus 1 can determine whether to continue playing the restricted-output section at SD (standard definition) or stop playing the restricted-output section.

As auxiliary related information, a status indication indicating whether a digital interface which enables proper high-definition display even in play intervals where high-definition analog video output is restricted is operative or not may be displayed as shown in the digital video output status display area 193 in FIG. 11. Since this digital interface status indication is stored beforehand as device authentication information in the temporary reproduction control information memory 12 as described with reference to FIG. 10, the system controller 11 can check the device authentication status quickly by the digital interface, by reading the information, without accessing the video display apparatus 4.

The digital interface status information does not have to be displayed on the warning screen as shown in FIG. 11; it may be displayed by an indicator, LED, or the like (not shown) included in the video content reproducing apparatus 1, for example; alternatively, it may be displayed on a setting screen for initial setup of the video content reproducing apparatus 1, or may be displayed on a separate screen when a special key is pressed on the control unit 3. By display of the digital interface status information on the video display apparatus 4 as shown in FIG. 11, a user interface can be provided such that the user can understand at a glance whether digital video that can be reproduced normally can be output even in play intervals where analog video output is restricted. By display of the digital interface status information, problems such as disconnection of the digital video output cable and abnormal device authentication can be immediately detected.

The video formats of the playlist, indicating the programs to be reproduced and sections where restricted output of analog reproduction is expected, may be displayed as further auxiliary related information as shown in the playlist configuration information display area 194 in FIG. 11. The information displayed in the playlist configuration information display area 194 provides the user of the video content reproducing apparatus 1 with detailed advance information about the number of play intervals in the playlist, sections with analog video output restrictions (marked with a warning icon in FIG. 11), the type of video restriction, and so on, as well as indicating the total playlist reproduction time. Therefore, if a sudden loss of picture or a change in definition occurs after the reproduction of the video content (play interval) of a title in the playlist, since the user already knows the situation, the user can continue viewing without becoming confused.

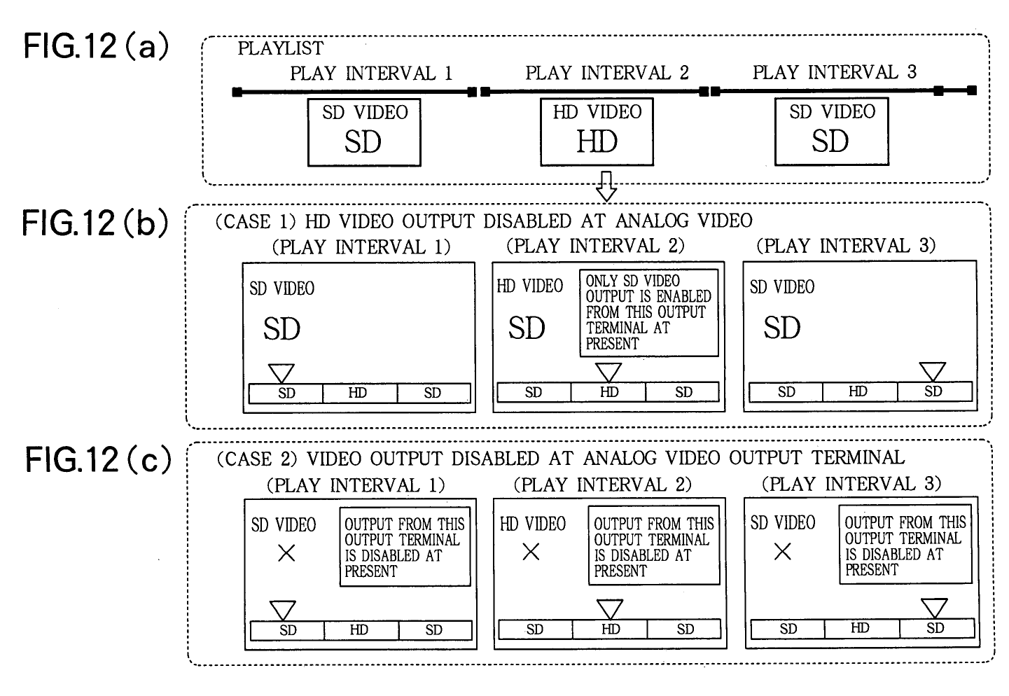

FIGS. 12(a) to 12(c) show exemplary screens displayed before the reproduction of segments in a playlist in which SD video content and HD video content are mixed, FIG. 12(a) indicating the recorded resolution of each play interval, FIG. 12(b) illustrating a Case 1 in which SD video is enabled at the analog video output terminal, FIG. 12(c) illustrating a Case 2 in which video output is disabled at the analog video output terminal. The exemplary screens shown in FIGS. 12(a) to 12(c) are displayed under the preconditions of the first embodiment, when a digital interface enabling high definition display cannot be used. When the system controller 11 detects an analog video output restriction on a segment of HD video content shown in FIG. 12(a), if SD analog output is enabled, the warning screen generator 35 generates a message stating that a shift to SD video content output will be made, as shown in play interval #2 in FIG. 12(b), before the play interval is displayed; if analog output is totally disabled, the warning screen generator 35 generates a message stating that no picture will be displayed, as shown in the play intervals in FIG. 12(c); the video mixer 36 adds these messages to the reproduced video content. The display screen may additionally display GUI items indicating the video format of the playlist representing the programs to be reproduced, segments in which reproduction restrictions are anticipated, and the current reproduction position, as shown at the bottom of the screens in FIGS. 12(b) and 12(c).

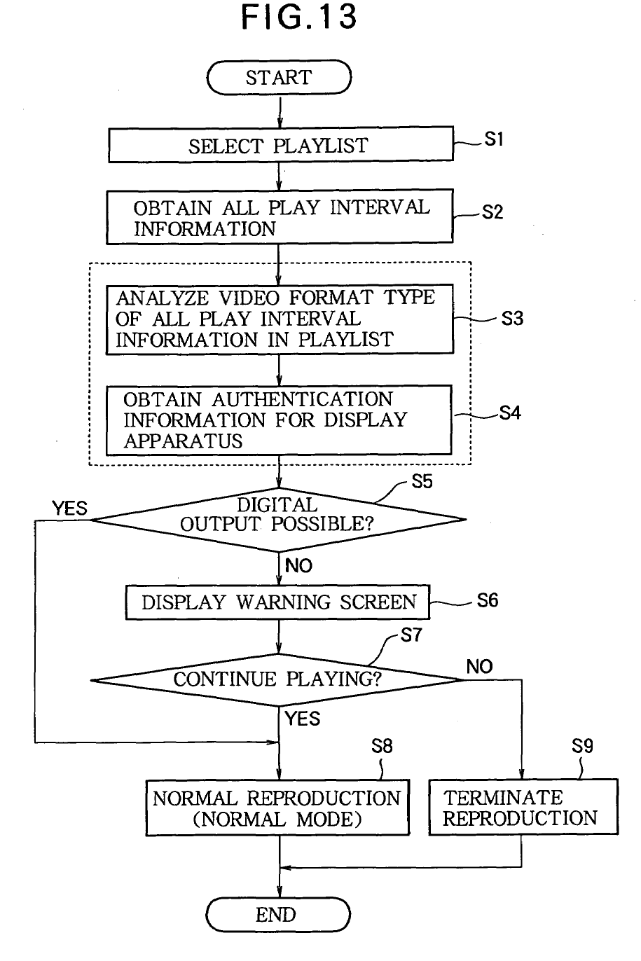

FIG. 13 is a flowchart illustrating the operation of the video content reproducing apparatus 1 shown in FIG. 1. An example of the operation of the video content reproducing apparatus 1 shown in FIG. 1 will be described in detail on the basis of FIG. 13, with reference to FIGS. 1 to 12(a) to 12(c) as necessary. When the optical disc 2 is inserted into the reproducing drive 31, the system controller 11 first reads the file system information stored in the file management information area 52 of the optical disc 2 and expands the logical directory structure shown in FIG. 3 from the file system information. The system controller 11 then outputs instructions (commands) to the other component units to read the reproduction control information file 71 and all of the address management files 72 recorded on the optical disc 2 into the temporary reproduction control information memory 12, and the component units execute the instructions.

Next, when the program number of a program to be reproduced is input from the control unit 3, the system controller 11 reads a playlist corresponding to the program number from the reproduction control information file 71 stored in the temporary reproduction control information memory 12 (step S1).

The system controller 11 reads the information concerning the one or more play intervals of the playlist from the reproduction control information file 71 and reads the “stream_name” 163, which is the name information of the address management file 72 to be reproduced, the “Start_Time” 164 representing the PTS at which reproduction starts, and the “End_Time” 165 representing the PTS at which reproduction ends from the information about all the play intervals in the playlist (step S2).

The system controller 11 then finds an access point including the PTS at which the reproduction of each play interval starts from the address management file 72 of the stream to be reproduced, which is stored in the temporary reproduction control information memory 12. More specifically, the access point management table is searched in ascending order of “PTS_GOP_Start” 152 to obtain the position information of the “SPN_GOP_Start” 153 of the access point including the PTS at which reproduction starts. The value to which the “SPN_GOP_Start” 153 detected in this manner is set indicates the position from which to start reading the stream defined in the play interval information.

From the attribute information management table recorded in the address management file 72, the system controller 11 then obtains the attribute information of the program including the position at which the reading of the stream starts. More specifically, because the information giving the starting SPN of the program is recorded under “SPN_Program_Start” 144, the program including the position at which the reading of the stream starts can be identified by searching in ascending order for the SPN to which the position at which the reading of the stream starts, as obtained above, belongs.

When the program is identified, the analog output decision unit 21 in the system controller 11 can obtain program attribute information such as the “Video_packet_ID” 145, “Audio_packet_ID” 146, “Stream_packet_ID” 147, “Format_Type” 148, “CopyRight_Info” 149, and “Codec_Type” 150 held in the play interval information, as well as stream ID information and so on. On the basis of the “Format_Type” 148, the system controller 11 obtains the video format information which distinguishes between HD video content and SD video content for each play interval by the method described above (step S3).

The information stored in the address management file 72 of the reproduction control information area 61 is used as a means for obtaining the video format in the first. embodiment, but the format may instead be made detected by using the ICT flag, which is an analog output restriction flag recorded in the stream information file 81 as described above, for example. In that case, it suffices to analyze the stream information file 81 in accordance with the ID number recorded in the “Stream_packet_ID” 147. In the analysis, all play intervals given in the play interval information may be checked to find places where video content output by an analog video signal is restricted, or when priority is placed on fast analysis, analog video output restrictions may be detected from the information concerning the entire play interval by using the information at the beginning of the play interval information.

The display device authentication decision unit 22 in the system controller 11 then conducts device authentication with the connected video display apparatus 4, to detect the functions of the display apparatus (step S4). The device authentication is performed before the reproduction of the recorded play interval of each title in the procedure shown in FIG. 10, to check whether there is an output terminal with which HD video content can be displayed normally. The timing at which the device authentication information is obtained is not limited to just before the reproduction of the playlist; it can be obtained any time before the reproduction of the video content (play interval) of the title, such as when the video content reproducing apparatus 1 is turned on.

To conduct this type of device authentication, the video content reproducing apparatus 1 may have to start device authentication by sending a video stream, and in that case, a video stream recorded on the optical disc 2 is usually used. The temporary reproduction control information memory 12 may also hold a prestored video stream so that device authentication can be performed even when the optical disc 2 is not inserted, for example. This configuration makes it possible to provide a video content reproducing apparatus 1 that can immediately conduct device authentication even when the optical disc 2 is not inserted. If the result of authentication obtained in the procedure described above is held in the temporary reproduction control information memory 12, device authentication can be performed quickly, without output of video from the optical disc 2. In that case, whether to perform device authentication or not may be selected on an initial setup screen or the like, so that the load on the system controller 11 will not be increased by the performance of unnecessary communication.

Based on the result of video format type analysis obtained in step S3 and the information concerning device authentication with the video display apparatus 4 obtained in step S4, the system controller 11 detects whether digital output is possible without the need to display the warning screen shown in FIG. 11 (step S5). More specifically, whether a shift to analog video output is needed is checked in accordance with the device authentication information obtained in conjunction with the video display apparatus 4. If digital video output to the video display apparatus 4 is usable, the decision in step S5 yields YES, making it unnecessary to display the warning screen shown in FIG. 11 and allowing the process to proceed to the normal reproduction step (step S8). If the digital video output cable is disconnected from the video display apparatus 4 or if the authentication mechanism for digital video output does not work, device authentication cannot be performed, so digital video output is unavailable and the warning screen will be displayed.

After that, the system controller 11 detects from the video format type given in the information for all play intervals held in the analog output decision unit 21 whether video content output by an analog video signal is restricted in any segment (step S5). If the detection result indicates that video content output by an analog video signal is not restricted in any segment, the decision in step S5 yields YES, making it unnecessary to display the warning screen shown in FIG. 11 and allowing the process to proceed to the normal reproduction step (S8).

If it is detected in step S5 that video content output by an analog video signal is restricted in a segment, the decision in step S5 yields NO, and the warning screen shown in FIG. 11 is displayed (step S6). Based on the information concerning the segment where video content output by an analog video signal is restricted, a GUI that the user of the video content reproducing apparatus 1 can easily comprehend visually is created and displayed as an OSD screen to notify the user in the warning screen. The user of the video content reproducing apparatus 1 may be reminded that the HD video content cannot be viewed on the video display apparatus 4 by indicating that the digital video output terminal is disabled, as shown in the digital video output status display area 193 in FIG. 11.

There is a strong possibility that the warning screen shown in FIG. 11 will be displayed each time the optical disc 2 becomes reproducible. In that case, a setting for hiding the warning screen itself may be made on an initial setup screen or the like.

Whether to continue reproduction is determined by selecting and clicking on the “normal play” button 191 or “stop playing” button 192 on the warning screen in FIG. 11 (step S7). When the “normal play” button 191 is clicked, the decision in step S7 yields YES, and processing proceeds to the normal reproduction step (step S8); when the “stop playing” button 192 is clicked, the decision in step S7 yields NO, terminating the reproduction of the selected program (step S9).

If normal reproduction is selected in step S8, the system controller 11 finds, by the method described above, an access point including the PTS at which reproduction starts from the address management file 72, deployed in the temporary reproduction control information memory 12, of the stream to be reproduced, and obtains the position information of the “SPN_GOP_Start” 153 of the access point including this starting PTS. The decoder block 13 then starts decoding from the position defined by the “SPN_GOP_Start” 153 item at the beginning of the stream information file 81 defined in the play interval information.

The demultiplexer 32 then separates the stream information file 81 into different types of packets in accordance with the ID numbers of the “Video_packet_ID” 145, “Audio_packet_ID” 146, and “Stream_packet_ID” 147 listed in the attribute information management table, and the information in the packets is input to the video decoder 33, audio decoder 34, and system decoder (not shown).

Video packets of video data are supplied to the video decoder 33, and the video content embodied in the decoded digital video signal is output to the video mixer 36 at the display time specified by the PTS of the packet. The audio decoder 34 also decodes audio packets at the display times specified by the PTS, and audio is output from the video display apparatus 4. Video and audio are reproduced successively in this manner, and when the time of the “End_time” 165 item indicating the PTS at which reproduction ends is reached, the output of the single play interval ends. The next play interval in the playlist can then be reproduced by the same procedure.

In a segment where analog video output is restricted, an OSD like the ones shown in FIGS. 12(b) and 12(c) may be displayed instead of the one shown in FIG. 11. In a segment where analog video output is restricted, the video decoder 33 outputs HD video content. Because the HD video content cannot be output to the video display apparatus 4, as described above, a scaler contained in the control unit 3 automatically converts the HD video content to SD video content, the copy control signal combiner 38 adds a copy control signal 181, and then the content is output to the video display apparatus 4. In the meantime, the warning screen generator 35 generates an OSD that explains the situation to the user of the video content reproducing apparatus 1, as shown in FIGS. 12(a) to 12(c), in accordance with the presence or absence of an output restriction section and the output restriction level, as specified from the system controller 11. After converting the format from the HD video content output from the video decoder 33 to SD video content, the video mixer 36 adds the video content of the digital video signal supplied from the warning screen generator 35 to generate a screen as shown in FIGS. 12(a) to 12(c) and displays the picture on the video display apparatus 4. When this type of explanatory OSD is added, the user can easily recognize that the video content reproducing apparatus 1 is not malfunctioning even if the video picture suddenly disappears or drops in resolution when a section with an analog video output restriction is reproduced.

The first embodiment shows an example in which the warning screen is displayed before the reproduction of the program (title) starts, but the screen may be displayed immediately after a position where analog video is restricted is detected. Whether to display the warning screen may be determined just from the result of analysis of the video format type in the playlist (step S3), skipping the step S4 shown in FIG. 13 for obtaining device authentication information.

In the first embodiment, whether a section where analog output of HD video content is restricted is included is detected before the reproduction of the video content (play interval) of the title starts, and the result of detection can be automatically displayed on the video display apparatus 4, so that the user of the video content reproducing apparatus 1 can know which sections of HD video content have analog output restrictions before reproduction starts. Therefore, even if the video picture disappears suddenly or deteriorates suddenly in quality, the user will not misinterpret this as a malfunction and can continue viewing the video content (play interval) of the title without feeling distressed.

### Second Embodiment

A video content reproducing apparatus 1 that can detect whether a section where analog output of HD video content is restricted is included before the reproduction of the video content (play interval) of the title starts and can automatically display the result of detection on the video display apparatus 4 has been described in the first embodiment; a method of conducting restricted reproduction of sections where video content output by an analog video signal is restricted will be described in the second embodiment. For example, a video display apparatus 4 having only an analog video input terminal can display nothing in a section in which analog video output is disabled, so any action to continue viewing the section is useless and meaningless. Accordingly, the second embodiment offers improved convenience by skipping or fast-forwarding such restricted intervals to quickly reach the next interval where HD video content can be reproduced normally.

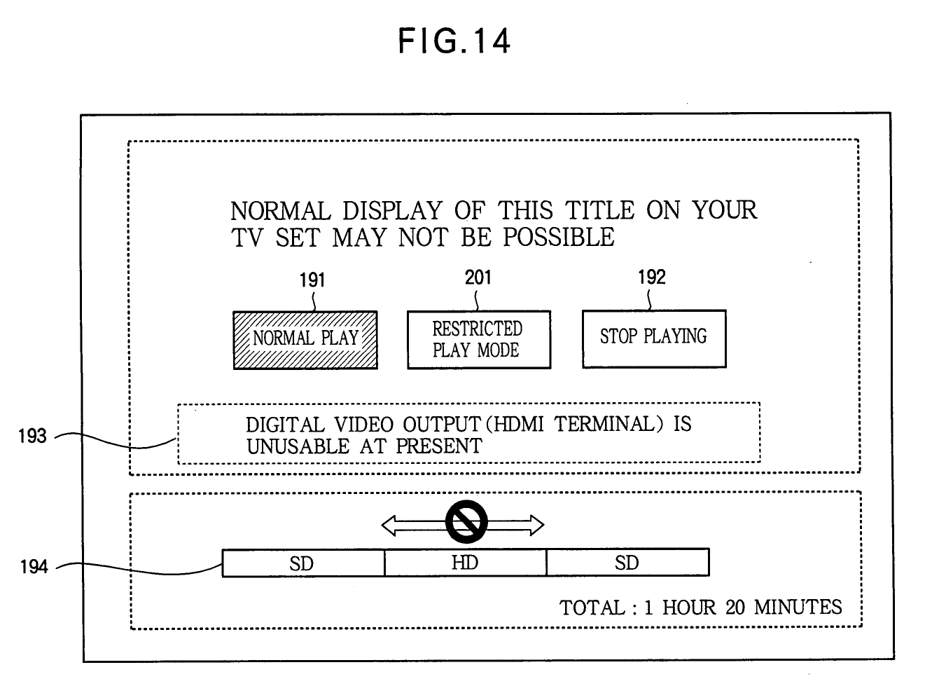

FIG. 14 shows an exemplary warning screen displayed by a video content reproducing apparatus in the second embodiment of the invention before the reproduction of a section of video content the output of which by an analog video signal is restricted, when the output terminal is a D3 terminal for analog video use. The warning screen has three buttons: a “normal play” button 191, “restricted play mode” button 201, and “stop playing” button 192. Acting through the control unit 3, the user of the video content reproducing apparatus 1 can reproduce the video content (play interval) of a title in a restricted reproduction mode, which will be described later.

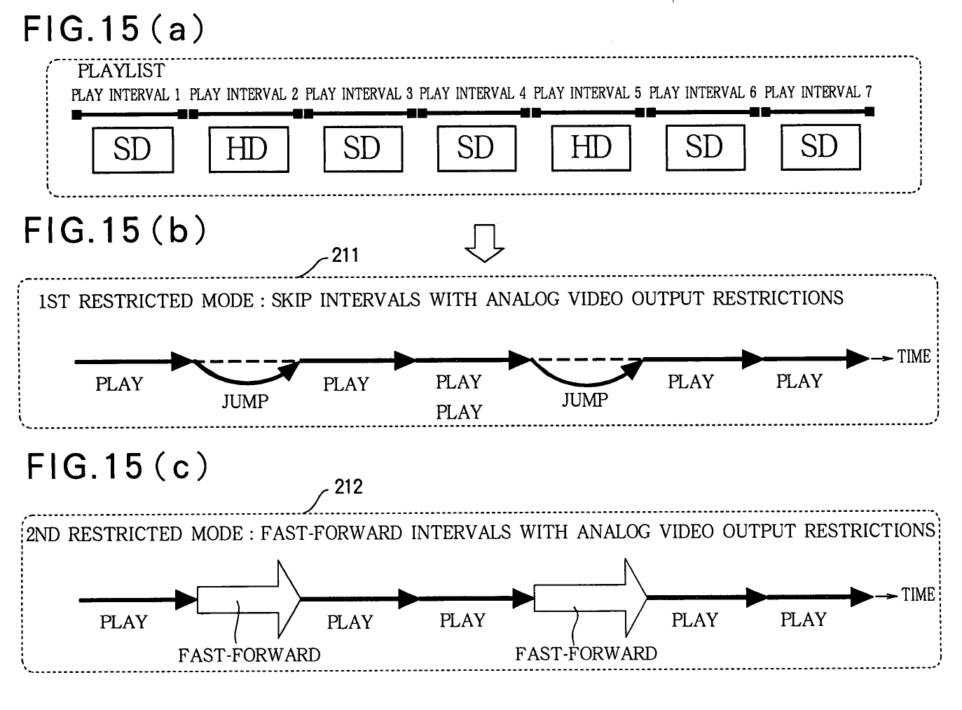

FIGS. 15(a) to 15(c) show examples of reproduction by the video content reproducing apparatus in the second embodiment in the restricted reproduction mode, FIG. 15(a) indicating the recorded resolution of each play interval, FIG. 15(b) illustrating a case in which restricted intervals are skipped during reproduction (first restricted play mode 211), and FIG. 15(c) showing a case in which the restricted intervals are fast-forwarded during reproduction (second restricted play mode 212). As shown in FIGS. 15(a) to 15(c), segments other than the segments in which analog video output is disabled are reproduced successively in the restricted reproduction mode. Reproducing the video content of the optical disc 2 as shown in FIGS. 15(a) to 15(c) enables the sections with analog video output restrictions to be skipped (first restricted play mode 211) or fast-forwarded (second restricted play mode 212) during the reproduction.

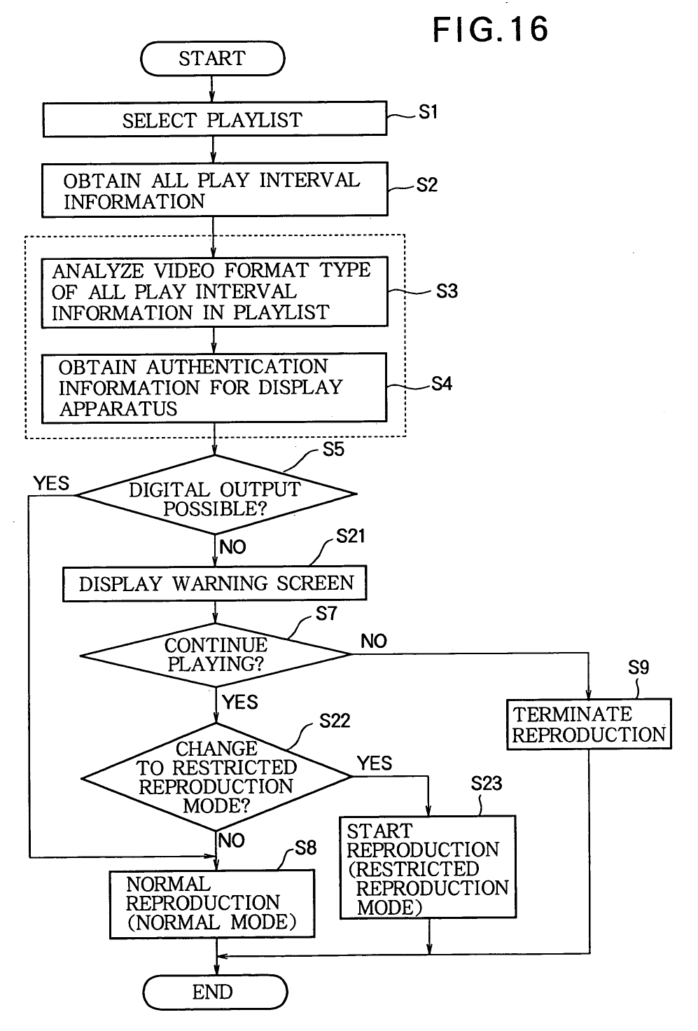

FIG. 16 is a flowchart illustrating the operation of the video content reproducing apparatus in the second embodiment. An example of the operation of the video content reproducing apparatus 1 of the second embodiment will be described in detail on the basis of FIG. 16, with reference to FIGS. 1 to 10, 12(a) to 12(c), 14, and 15(a) to 15(c) as necessary. In FIGS. 14 and 16, elements that are identical to or correspond to elements in the first embodiment will be denoted by the same reference characters.

The processing in steps S1 to S5, S7, S8, and S9 in FIG. 16 is the same as in the first embodiment. In the second embodiment, an example of reproduction in the first restricted play mode 211, in which the analog video output restriction section in FIG. 15(b) is skipped when the “restricted play mode” button 201 is clicked on the warning screen in FIG. 14, will be described.

In step S5, if the video display apparatus 4 can make use of digital video output and if video content output by an analog video signal is not restricted in any section, the decision in step S5 yields YES, making it unnecessary to display the warning screen shown in FIG. 14 and allowing processing to proceed to the normal reproduction step (step S8). If it is detected in step S5 that the warning screen should be output because digital output is disabled, the decision in step S5 yields NO, and the warning screen shown in FIG. 14 is displayed (step S21).

Whether to continue reproduction is determined by selecting and clicking on the “normal play” button 191, “restricted play mode” button 201, or “stop playing” button 192 on the warning screen in FIG. 14, (step S7). Selecting and clicking on the “normal play” button 191 or “restricted play mode” button 201 determines whether reproduction is continued as normal reproduction or restricted reproduction (step S22).

If the user clicks on the “restricted play mode” button 201 by using the control unit 3, the decision in step S7 yields YES, and the decision in step S22 yields YES, starting the reproduction of the video content (play interval) of the title in the restricted reproduction mode. Before the reproduction of the video content (play interval) of the title, the system controller 11 obtains the information about the sections with analog video output restrictions (a list of restriction starting times and restriction ending times) in the playlist held in the analog output decision unit 21. Then, the system controller 11 reproduces the play intervals successively, starting from play interval #1 at the beginning of the playlist. When the starting time of a section with an analog video output restriction is reached, a jump is made to the ending time of the section with the analog video output restriction by using a chapter search or time search. Normal reproduction continues from the starting time of the next play interval. By repetition of this process as necessary, reproduction can continue with the sections with analog video output restrictions being skipped. The address of the stream information file is derived from the starting time by the method described in the first embodiment.

If the user clicks on the “restricted play mode” button 201 on the warning screen in FIG. 14 by using the control unit 3, the decision in step S7 yields YES, the decision in step 22 yields YES, and reproduction can be conducted in the second restricted play mode 212, in which the analog video output restriction section is fast-forwarded as shown in FIG. 15(c). In that case, the process until the system controller 11 obtains the information about sections in which video content output by an analog video signal is restricted (the list of restriction starting times and restriction ending times) is the same as in the first restricted play mode 211. Reproduction is then executed successively from play interval #1, which is the first play interval of the playlist, and when the starting time of a section with an analog video output restriction is reached, special reproduction such as fast-forwarding is executed until the ending time of the section with the analog video output restriction. A shift back to normal reproduction (single-speed reproduction) is made at the starting time of the next play interval. By repetition of this process as necessary, the sections with analog video output restrictions can be fast-forwarded by special reproduction. The method of calculating the address of the stream information file from the starting time has already been described in the first embodiment.

When a chapter jump or a time search attempts to start reproduction from a section in which video content output by an analog video signal is restricted, reproduction may be started from the beginning of the next play interval where normal reproduction is possible. In that case, a message providing additional information, stating that an attempt has been made to reproduce a section with an analog output restriction so reproduction will continue from the next chapter, for example, may be displayed as a notification to the user of the video content reproducing apparatus 1.

In executing reproduction, the video content reproducing apparatus 1 of the second embodiment deals with segments in which analog output of HD video content is restricted by automatically skipping (jumping over) the sections in which analog display of HD video content is restricted, thereby preventing the problem of an absent analog video display in sections of HD video content with analog output restrictions, that is, preventing the reproduction of useless video sections in which no picture is output, and making it possible to display video without interruption. In addition, a section in which display is enabled can be reached quickly by fast-forwarding through a section in which display is disabled.

1-16. (canceled)

17. A video content reproducing apparatus for reproducing video content recorded with prescribed copyright protection processing on an information recording medium, having a video output means for outputting the reproduced video signal, the video content reproducing apparatus comprising:
a display device authentication decision unit for authenticating a video display apparatus connected to the video content reproducing apparatus and deciding, based on a result of the authentication, whether to output a video signal of the video content protected by the copyright protection processing as a digital video signal or after conversion to an analog video signal;
an analog output decision unit for determining, for each play interval forming a unit of reproduction of the video content in the video signal of the video content recorded on the information recording medium, whether or not a restriction has been imposed by the copyright protection processing on output after conversion to an analog video signal; and
a system control unit for controlling the video output means according to results of decisions by the display device authentication decision unit and the analog output decision unit so as, if the video display apparatus is determined to be an apparatus requiring the video signal of the video content to be converted to an analog video signal, to convert the video signal of the play interval on which said restriction has been determined to be imposed to an analog video signal with lowered resolution, then output the analog video signal to the video display apparatus.

18. The video content reproducing apparatus of claim 17, wherein:
the display device authentication decision unit uses a DTCP (Digital Transmission Content Protection) device authentication protocol to determine whether or not the video display apparatus is compatible with the digital video signal of each play interval; and
the analog output decision unit determines whether the restriction is imposed or not according to information in an ICT (Image Constraint Token) in a stream information file corresponding to the video content.

19. The video content reproducing apparatus of claim 17, further comprising at least one of a display unit for displaying a result determined by the analog output decision unit and a warning screen generator for outputting, to the video display apparatus, a video signal for displaying the result determined by the analog output decision unit, wherein:
if the video display apparatus is determined to be an apparatus requiring the video signal of the video content to be converted to an analog video signal and the restriction is determined to be imposed on a play interval of the video content, the system control unit controls the warning screen generator so as to output a video signal for displaying a result of the determination to the display unit or the video display apparatus before reproduction of the play interval.

20. A video content reproducing method for playing an information recording medium on which a video signal of video content is recorded with prescribed copyright protection processing and outputting the reproduced video signal, the video content reproducing method comprising:
a display apparatus decision step in which a video content reproducing apparatus authenticates a video display apparatus connected to the video content reproducing apparatus and decides, based on a result of the authentication, whether to output a video signal of the video content protected by the copyright protection processing as a digital video signal or after conversion to an analog video signal;
an analog output decision step in which the video content reproducing apparatus determines, for each play interval forming a unit of reproduction of the video content in the video signal of the video content recorded on the information recording medium, whether or not a restriction has been imposed by the copyright protection processing on output after conversion to an analog video signal; and
a video output control step in which the video content reproducing apparatus controls the video output according to results of decisions in the display apparatus decision step and the analog output decision step so as, if the video display apparatus is determined to be an apparatus requiring the video signal of the video content to be converted to an analog video signal, to convert the video signal of a play interval on which said restriction has been determined to be imposed to an analog video signal with lowered resolution, then output the analog video signal to the video display apparatus.

21. The video content reproducing method of claim 20, wherein:
the display apparatus decision step uses a DTCP (Digital Transmission Content Protection) device authentication protocol to determine whether or not the video display apparatus is compatible with the digital video signal of each play interval; and
the analog output decision step determines whether the restriction is imposed or not according to information in an ICT (Image Constraint Token) in a stream information file corresponding to the video content.

22. The video content reproducing method of claim 20, comprising a warning screen generating step in which if the video display apparatus is determined to be an apparatus requiring the video signal of the video content to be converted to an analog video signal and the restriction is determined to be imposed on a play interval of the video content, a video signal for displaying a result of the determination is output to the video display apparatus before reproduction of the play interval.
